(19) United States
(12) Patent Application Publication
(10) Pub. No.: US 2026/0066507 A1
(43) Pub. Date: Mar. 5, 2026

(54) BATTERY

(71) Applicant: ZHUHAI COSMX BATTERY CO., LTD., Zhuhai (CN)

(72) Inventors: Zengke Huang, Zhuhai (CN); Qiuwan Jiang, Zhuhai (CN)

(21) Appl. No.: 19/315,831

(22) Filed: Sep. 1, 2025

(30) Foreign Application Priority Data
Sep. 5, 2024 (CN) 202422182532.3

(51) Int. Cl. H01M 50/591; H01M 50/105; H01M 50/202; H01M 50/242; H01M 50/574

(52) U.S. Cl. CPC H01M 50/591; H01M 50/105; H01M 50/202; H01M 50/242; H01M 50/574

(57) ABSTRACT

A battery, including a cell, a protection board and an injection-molded plastic structure. The injection-molded plastic structure encloses at least a tab, a top sealing edge, a main board and a portion of a flexible printed circuit board, an output end of the flexible printed circuit board is located outside the injection-molded plastic structure, and a groove is formed on the injection-molded plastic structure at a position corresponding to where the output end extends, with at least a portion of the output end being located within the groove. The groove has a minimum groove width of not less than 2 mm in a first direction, and has a groove depth of not less than 0.5 mm in a second direction. In this way, the injection-molded plastic structure provides effective protection for elements such as the protection board, and ensures a sufficient space for movement of the flexible printed circuit board.

### CROSS-REFERENCE TO RELATED APPLICATIONS

The present application claims priority to Chinese Patent Application No. CN202422182532.3, titled “BATTERY,” filed on Sep. 5, 2024, the entire contents of which are incorporated herein by reference.

### TECHNICAL FIELD

The disclosure relates to the technical field of batteries, and in particular to a battery.

### BACKGROUND ART

Lithium-ion batteries are widely used not only in portable electronic devices such as mobile phones and notebook computers, but also in electric vehicles, electric bicycles, energy storage facilities, battery swap stations, intelligent equipment, and other applications.

A cell is one of the main components of a battery. In the related art, a protection board is typically disposed on the top of the cell to protect the cell from damage or an explosion risk caused by abnormal conditions such as overcharging, overdischarging, or short circuit. However, in the battery of the related art, for example during drop tests or similar conditions, elements located on the top of the cell, such as the protection board, may be damaged due to impacts.

### SUMMARY

In view of the above, embodiments of the disclosure are directed to providing a battery, so as to at least realize the protection of elements such as the protection board on a top of a cell, and to facilitate the adjustment of a position of an output end of the protection board.

The disclosure provides a battery, including a cell, a protection board and an injection-molded plastic structure,
where the cell has a tab and a top sealing edge, the tab extending from the top sealing edge; the protection board is connected to the tab, the protection board including a main board located on a side of the top sealing edge facing away from the cell and at least one flexible printed circuit board connected to the main board;
the injection-molded plastic structure encloses at least the tab, the top sealing edge, the main board and a portion of the flexible printed circuit board, an output end of the flexible printed circuit board is located outside the injection-molded plastic structure, and a groove is formed on the injection-molded plastic structure at a position corresponding to where the output end extends, with at least a portion of the output end being located within the groove; and
the groove has a minimum groove width of not less than 2 mm in a first direction, and the groove has a groove depth of not less than 0.5 mm in a second direction.

Optionally, the groove includes a first side groove wall and a groove base wall connected to an end of the first side groove wall that is close to the top sealing edge, and the output end extends into the groove from the first side groove wall.

Optionally, an included angle between the first side groove wall and the groove base wall ranges from 90° to 100°;
and/or a groove opening of the groove has a width in the first direction that is greater than a width of a groove base of the groove in the first direction, and the groove base wall has a width of not less than 2 mm in the first direction.

Optionally, the top sealing edge is formed with a sealing edge protrusion on at least one side in the first direction, and the injection-molded plastic structure further encloses the sealing edge protrusion.

Optionally, an injection-molded boss is formed in a region of the injection-molded plastic structure that correspondingly encloses the sealing edge protrusion; and the groove further includes a second side groove wall disposed opposite the first side groove wall, an end of the second side groove wall that is close to the top sealing edge is connected to
the groove base wall, and a side of the injection-molded boss facing the output end is formed as the second side groove wall.

Optionally, a top face of the injection-molded boss has a width of not less than 1.5 mm in the first direction.

Optionally, a level of a face of the output end that is close to the top sealing edge is not higher than a level of a top face of the sealing edge protrusion;
and/or an included angle between the second side groove wall and the groove base wall ranges from 90° to 150°.

Optionally, the angle between the second side groove wall and the groove base wall ranges from 95° to 140°.

Optionally, a level of a face of the output end that is close to the top sealing edge is higher than a level of a top face of the sealing edge protrusion;
and/or an included angle between a top face of a region of the injection-molded plastic structure that encloses the sealing edge protrusion and a horizontal plane ranges from −10° to 10°;
and/or the top face of the region of the injection-molded plastic structure that encloses the sealing edge protrusion is not higher than the groove base wall of the groove.

Optionally, the flexible printed circuit board is disposed on at least one side of the protection board in the first direction; and
a level of a top face of a region of the injection-molded plastic structure that at least encloses the main board is lower not than a level of a top face of the injection-molded boss.

The battery provided by the disclosure protects the elements located on the top of the cell, such as the tab, the top sealing edge, the main board of the protection board and a portion of the flexible printed circuit board, by means of the injection-molded plastic structure disposed on the top of the cell. This avoids situations such as damage to the elements located on the top of the cell, such as the protection board, caused by impacts (for example, during drop tests).

In addition, the groove is formed on the injection-molded plastic structure at a position corresponding to the output end of the flexible printed circuit board, such that at least a bending initiation point of the flexible printed circuit board is located within the groove. This facilitates bending of the flexible printed circuit board according to an actual condition, thereby allowing adjustment of the specific position of the output end. Moreover, the minimum groove width of the groove in the first direction is set to be not less than 2 mm, so that the groove can accommodate more redundant dimensions of the flexible printed circuit board, thereby further ensuring a sufficient space for movement of the flexible printed circuit board, facilitating bending adjustment of the flexible printed circuit board, and improving production efficiency.

Furthermore, the groove depth of the groove in the second direction is set to be not less than 0.5 mm, so that the groove can at least protect and, to a certain extent, accommodate and conceal a bent portion of the output end of the flexible printed circuit board while further ensuring a sufficient space for movement of the flexible printed circuit board, thereby avoiding situations such as damage caused by compression due to the bent portion of the output end of the flexible printed circuit board excessively protruding from the plane of the groove opening of the groove. In addition, such an arrangement can reduce the space occupied by the flexible printed circuit board in the length direction of the cell, thereby reducing the overall volume of the battery and increasing the energy density of the battery.

That is, the battery provided by the disclosure not only enables effective protection of elements such as the protection board located on the top of the cell, thereby reducing, to a certain extent, the risk of damage to the elements caused by impacts. Moreover, it ensures that the flexible printed circuit board has a sufficient active space, facilitating flexible adjustment of the position of the output end of the flexible printed circuit board, and it is also possible to better accommodate and conceal the bent portion of the flexible printed circuit board, thereby avoiding situations such as damage caused by compression, and further increasing the energy density of the battery.

### BRIEF DESCRIPTION OF THE DRAWINGS

FIG. 1 is a schematic structural diagram of a cell according to an embodiment of the disclosure before a sealing edge is bent;

FIG. 2 is a schematic structural diagram of the cell according to the embodiment of the disclosure after the sealing edge is bent;

FIG. 3 is a schematic structural diagram of the cell according to the embodiment of the disclosure after a protection board is connected thereto;

FIG. 4 is a side structural diagram corresponding to FIG. 3;

FIG. 5 is an enlarged structural diagram of part I in FIG. 4;

FIG. 6 is a first schematic structural diagram of a battery according to an embodiment of the disclosure;

FIG. 7 is an enlarged structural diagram of part I in FIG. 6;

FIG. 8 is a second schematic structural diagram of the battery according to the embodiment of the disclosure;

FIG. 9 is an exploded schematic structural diagram of the battery shown in FIG. 8;

FIG. 10 is an enlarged structural diagram of part I in FIG. 9; and

FIG. 11 is a third schematic structural diagram of the battery according to the embodiment of the disclosure.

In the figures: 1. cell; 11. housing; 111. top sealing edge; 112. side sealing edge; 113. scaling edge protrusion; 12. tab; 2. protection board; 21. main board; 22. flexible printed circuit board; 221. output end; 222. connector; 223. first connecting section; 224. bendable section; 225. second connecting section; 3. injection-molded plastic structure; 31. groove; 311. first side groove wall; 312. second side groove wall; 313. groove base wall; 32. injection-molded boss; 4. first insulating member; 5. second insulating member.

### DETAILED DESCRIPTION OF EMBODIMENTS

The technical solutions in the embodiments of the disclosure will be clearly and completely described below with reference to the accompanying drawings in the embodiments of the disclosure. Apparently, the embodiments described are some of, rather than all of, the embodiments of the disclosure. All other embodiments obtained by those of ordinary skill in the art based on the embodiments of the disclosure without creative efforts shall fall within the scope of protection of the disclosure.

A cell is one of the main components of a battery. In the related art, a protection board is typically disposed on the top of the cell to protect the cell from damage or an explosion risk caused by abnormal conditions such as overcharging, overdischarging, or short circuit. However, in the battery of the related art, for example, during drop tests or the like, or if the battery is accidentally dropped during use, elements located on the top of the cell, such as the protection board, may be damaged due to impacts.

In view of this, the disclosure provides a battery. An injection-molded plastic structure is disposed on a top of a cell. The injection-molded plastic structure protects elements located on the top of the cell, such as a tab, a top sealing edge, a main board of a protection board, and a portion of a flexible printed circuit board, thereby avoiding situations such as damage to the elements caused by impacts. Moreover, a groove is formed on the injection-molded plastic structure at a position corresponding to an output end of the flexible printed circuit board. Through the design of the dimensions of the groove, a sufficient space for movement of the flexible printed circuit board is ensured, making it easier to bend the flexible printed circuit board and adjust the specific position of the output end of the flexible printed circuit board.

The battery provided by the disclosure will be described in detail below by way of specific embodiments with reference to the accompanying drawings.

This embodiment provides a battery, which may, for example, be a lithium-ion battery. The battery may be used as a power source or an energy storage unit for electronic devices. The electronic devices may include, but are not limited to, mobile devices (such as mobile phones, notebook computers, and tablet computers) and electric vehicles (e.g., pure electric vehicles, hybrid electric vehicles, and electric bicycles).

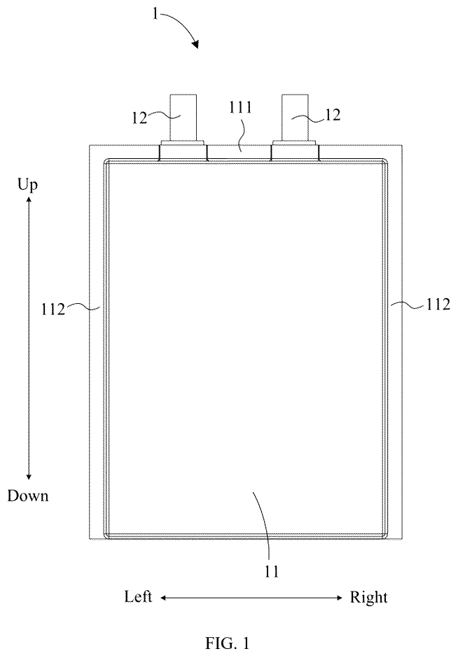

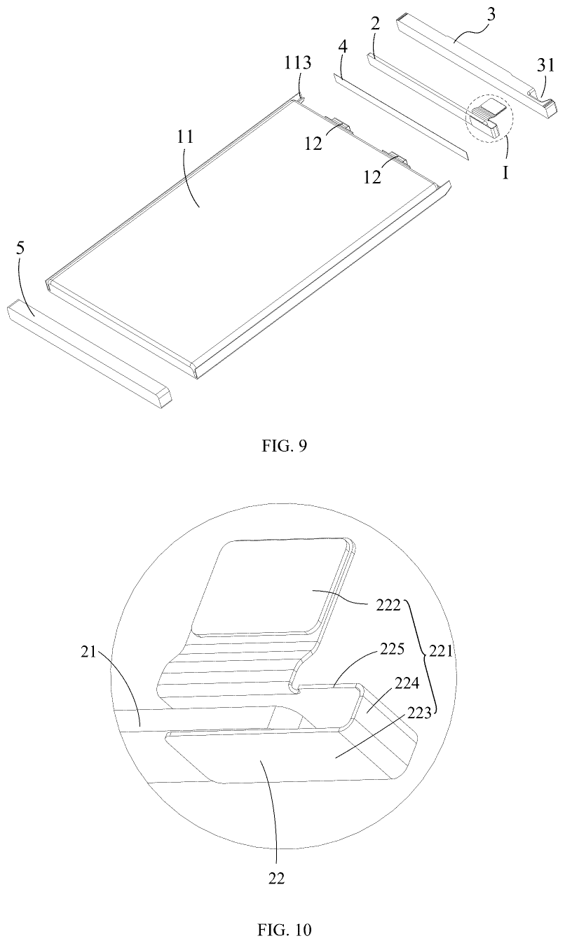

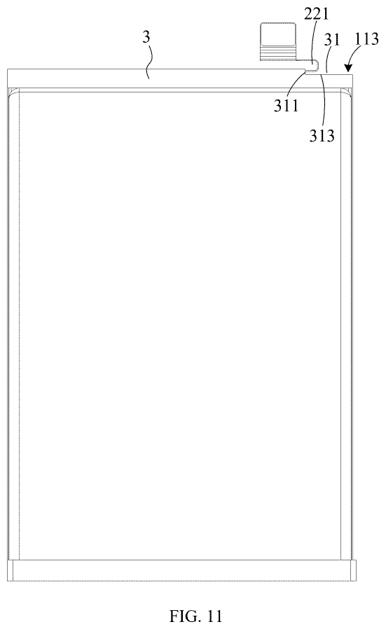

With reference to FIGS. 1 to 11, the battery provided in this embodiment includes: a cell 1, a protection board 2, and an injection-molded plastic structure 3.

The cell 1 specifically includes: a cell body, a housing 11, and a tab 12. The cell body is located inside the housing 11, and the tab 12 is connected to the cell body.

With reference to FIG. 1, the housing 11 may specifically include a housing body, a top sealing edge 111 and a side sealing edge 112. The housing body encloses the cell body. Both the side sealing edge 112 and the top sealing edge 111 extend from the housing body. The top sealing edge 111 extends from a top face of the housing body, and the side sealing edge 112 extends from a side face of the housing body. Illustratively, the cell 1 has two tabs 12. Both tabs 12 extend from the top sealing edge 111 to the outside of the housing 11. The housing 11 may specifically be, for example, an aluminum-plastic film housing.

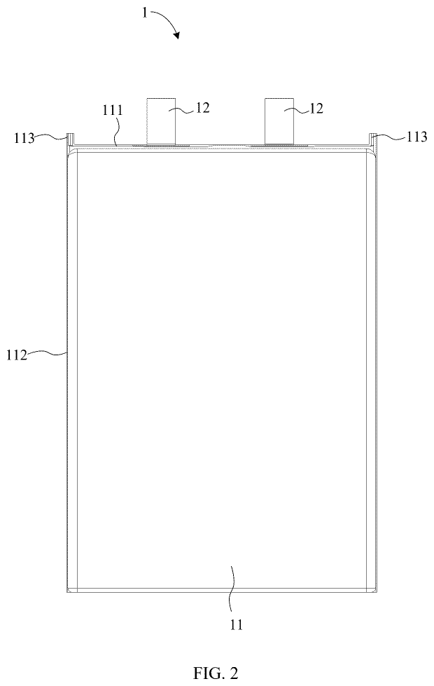

With reference to FIGS. 1 and 2, during encapsulation, it is necessary to bend the top scaling edge 111 and the side sealing edge 112, that is, to bend the top sealing edge 111 toward the top face of the cell 1. For example, a top sealing plate is fixed to the top face of the cell 1 by means of bending and adhesive dispensing or by means of a double-sided adhesive tape. Similarly, the side sealing edge 112 is bent toward the side face of the cell 1 and, for example, is fixed to the side face of the cell 1 by means of bending and adhesive dispensing or by means of a double-sided adhesive tape.

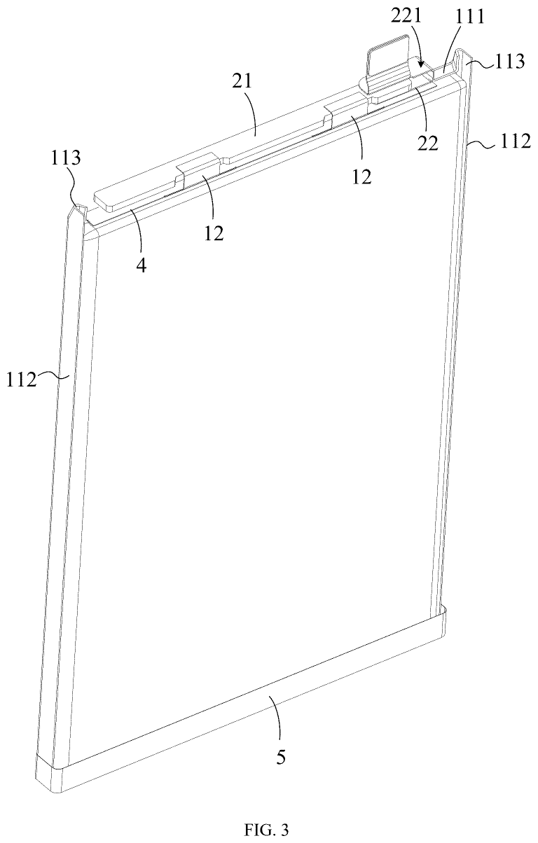

With reference to FIG. 3, the protection board 2 is located specifically on the top of the cell 1. The protection board 2 is connected to the tabs 12 and is configured for connection with an external electrical device, enabling indirect connection of the cell 1. The protection board 2 can be used to protect the cell 1 from damage or explosion and other risks caused by abnormal conditions such as overcharging, overdischarging, or short circuit.

The protection board 2 includes a main board 21 located on a side of the top sealing edge 111 facing away from the cell 1 and at least one flexible printed circuit (FPC) board 22 connected to the main board 21.

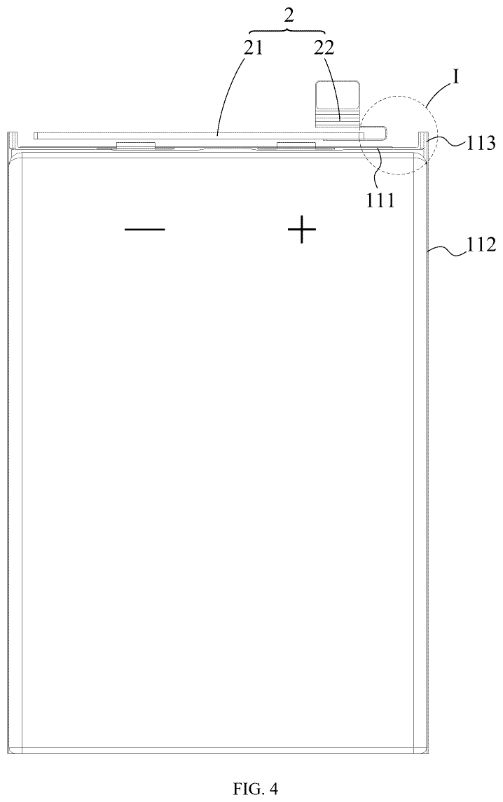

Illustratively, the main board 21 has welding positions to which the tabs 12 are welded. After the tabs 12 are welded to the protection board 2, the protection board 2 and the tabs 12 are turned, as shown in FIGS. 3 and 4, so that the protection board 2 is located on the side of the top sealing edge 111 facing away from the cell 1.

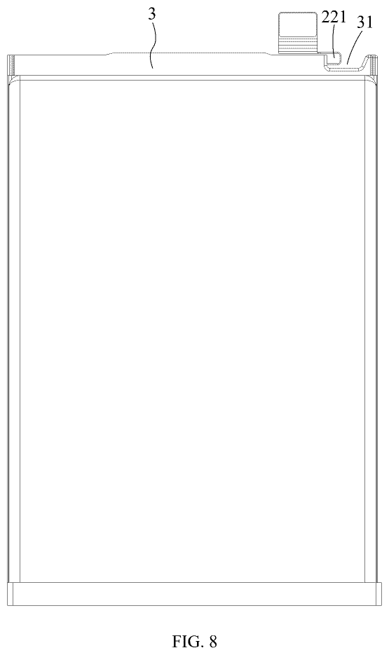

With reference to FIG. 8, in a specific implementation, a first insulating member 4 may further be provided between the protection board 2 and the top sealing edge 111 to prevent a short circuit caused by contact between the protection board 2 and other components. In addition, a second insulating member 5 may be provided at the bottom of the cell 1 to provide insulating protection for the bottom of the cell 1. The first insulating member 4 and the second insulating member 5 may both be, for example, insulating tapes.

The injection-molded plastic structure 3 encloses at least the tabs 12, the top sealing edge 111, the main board 21, and a portion of the flexible printed circuit board 22. An output end 221 of the flexible printed circuit board 22 is located outside the injection-molded plastic structure 3, and a groove 31 is formed on the injection-molded plastic structure 3 at a position corresponding to where the output end 221 extends. At least a portion of the output end 221 is located within the groove 31.

That is, the injection-molded plastic structure 3 is formed on the top of the cell 1 through injection molding, to provide insulating protection for at least the tabs 12, the top sealing edge 111, the main board 21, and a portion of the flexible printed circuit board 22, thereby preventing damage to elements caused by impacts and other situations to the battery.

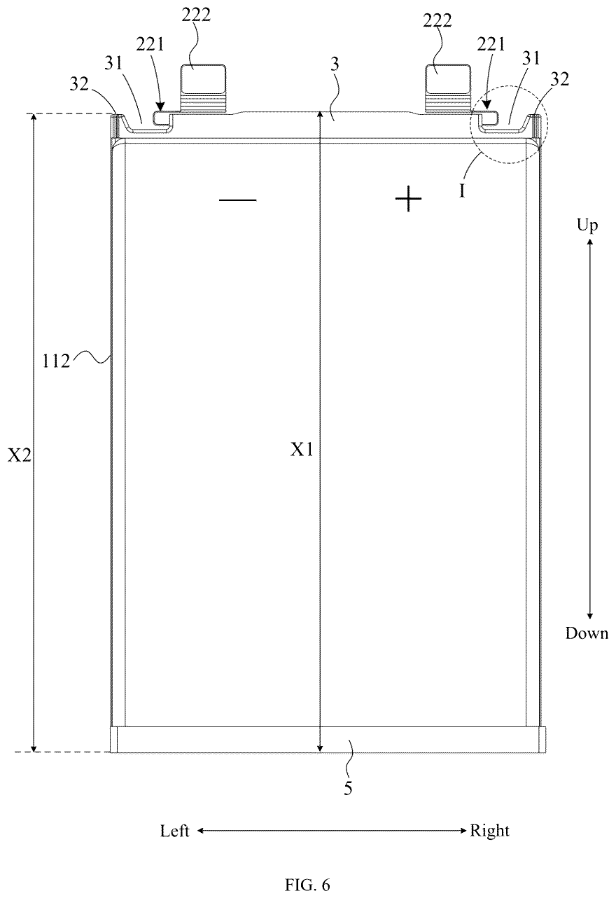

Specifically, the output end 221 of the flexible printed circuit board 22 is connected to an external device. With reference to FIGS. 6 to 10, the output end 221 of the flexible printed circuit board 22 may specifically include a first connecting section 223, a bendable section 224, a second connecting section 225, and a connector 222. The first connecting section 223 is connected to the main board 21, the bendable section 224 is connected between the first connecting section 223 and the second connecting section 225, and the connector 222 is connected to the second connecting section 225. The protection board 2 establishes electrical connection with the external device specifically via the connector 222. In a specific implementation, after injection molding is completed, it is necessary to adjust the specific position of the connector 222 to achieve reliable and convenient connection of the connector 222 with the external device. The adjustment of the specific position of the connector 222 is achieved specifically by adjusting the position of the bent portion of the output end 221 of the flexible printed circuit board 22.

A groove 31 is formed at the position of the injection-molded plastic structure 3 corresponding to where the output end 221 of the flexible printed circuit board 22 extends, so that at least a portion of the output end 221 is located within the groove 31. This allows adjustment of the position of the bent portion of the flexible printed circuit board 22, thereby achieving the adjustment of the position of the connector 222 of the output end 221 of the flexible printed circuit board 22.

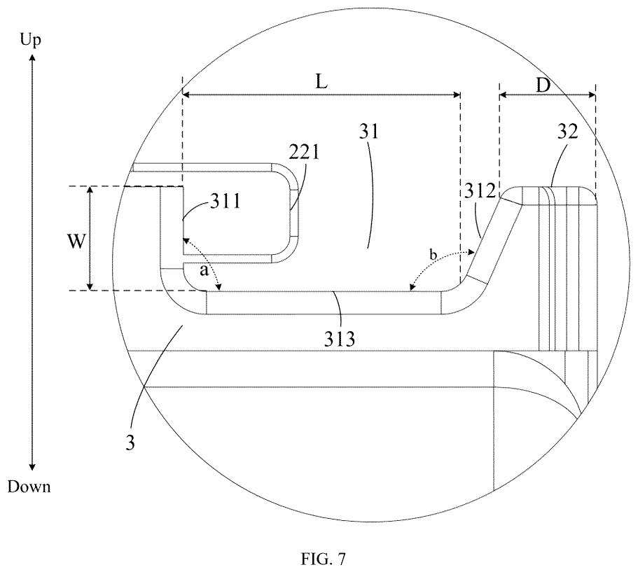

If the groove 31 has too small a groove width in the first direction, it will result in a small space for movement of the flexible printed circuit board 22 when adjusting the bent portion of the flexible printed circuit board 22, making it difficult to bend the flexible printed circuit board 22. In view of this, with reference to FIGS. 6 and 7, in this embodiment, the minimum groove width L of the groove 31 in the first direction is set to be not less than 2 mm. Illustratively, the minimum groove width L of the groove 31 may be, for example, 2 mm, 2.2 mm, 2.5 mm, 3 mm, 3.5 mm, 4 mm, or 4.5 mm.

It should be noted that the first direction specifically refers to the left-right direction in FIGS. 6 and 7, which may be, for example, the width direction of the cell 1. The groove width L of the groove 31 specifically refers to the dimension of the groove 31 in the left-right direction.

It can be understood that in some feasible implementations, the groove width of the groove 31 in the direction from the groove opening to the groove base of the groove 31 may be uniform. In this case, the minimum groove width of the groove 31 in the first direction is the groove width of the groove 31 in the first direction. In other feasible implementations, with reference to FIG. 7, the groove width of the groove 31 in the direction from the groove opening to the groove base of the groove 31 may vary. For example, in the direction from the groove opening to the groove base of the groove 31, the groove width of the groove 31 gradually decreases. In this case, the minimum groove width L of the groove 31 in the first direction is the width of the groove base of the groove 31 in the first direction.

Through the above arrangement, it can be further ensured that the bending initiation point of the output end 221 of the flexible printed circuit board 22 can be located at any position within the groove 31, so that the groove 31 can accommodate more redundant dimensions of the flexible printed circuit board 22, increasing the active space of the flexible printed circuit board 22, facilitating the bending adjustment of the flexible printed circuit board 22, and improving production efficiency.

If the groove 31 has too small a groove depth in the second direction, it will result in the groove 31 being unable to effectively accommodate the bent portion of the output end 221 of the flexible printed circuit board 22. This will cause the output end 221 of the flexible printed circuit board 22 to protrude significantly from the top face of the injection-molded plastic structure 3, taking up more space in the thickness direction of the battery. In view of this, with continued reference to FIG. 7, the groove depth W of the groove 31 in the second direction may be set to be not less than 0.5 mm. Illustratively, the groove depth W may be, for example, 0.5 mm, 0.55 mm, 0.6 mm, 0.65 mm, 0.7 mm, 0.75 mm, or 0.8 mm.

It should be noted that the second direction herein specifically refers to the up-down direction in FIG. 7, which may be, for example, the length direction of the cell 1. The groove depth W herein specifically refers to the depth dimension of the groove 31 in the up-down direction.

Such an arrangement can not only further ensure the space for movement of the flexible printed circuit board 22, but can also enable the groove 31 to at least protect and, to a certain extent, accommodate and conceal the bent portion of the output end 221 of the flexible printed circuit board 22, thereby avoiding situations such as damage caused by compression due to the bent portion of the output end 221 of the flexible printed circuit board 22 excessively protruding from the plane of the groove opening of the groove 31. Moreover, such an arrangement can reduce the space occupied by the flexible printed circuit board 22 in the length direction of the cell 1, thereby reducing the overall volume of the battery and increasing the energy density of the battery.

In the battery provided by this embodiment, by providing the injection-molded plastic structure 3 on the top of the cell 1, the elements located on the top of the cell 1, such as the tab 12, the top sealing edge 111, the main board 21 of the protection board 2, and a portion of the flexible printed circuit board 22 are protected by the injection-molded plastic structure 3. This avoids situations such as damage to the elements located on the top of the cell 1, such as the protection board 2, caused by impacts (for example, during drop tests). In addition, the groove 31 is formed on the injection-molded plastic structure 3 at a position corresponding to the output end 221 of the flexible printed circuit board 22, such that at least a bending initiation point of the flexible printed circuit board 22 is located within the groove 31. This facilitates bending of the flexible printed circuit board 22 according to an actual condition, thereby allowing adjustment of the specific position of the output end 221. Moreover, the minimum groove width of the groove 31 in the first direction is set to be not less than 2 mm, so that the groove 31 can accommodate more redundant dimensions of the flexible printed circuit board 22, thereby further ensuring a sufficient space for movement of the flexible printed circuit board 22, facilitating bending adjustment of the flexible printed circuit board 22, and improving production efficiency. Furthermore, the groove depth of the groove 31 in the second direction is set to be not less than 0.5 mm, so that the groove 31 can at least protect and, to a certain extent, accommodate and conceal a bent portion of the output end 221 of the flexible printed circuit board while further ensuring a sufficient space for movement of the flexible printed circuit board 22, thereby avoiding situations such as damage caused by compression due to the bent portion of the output end 221 of the flexible printed circuit board excessively protruding from the plane of the groove opening of the groove 31. In addition, such an arrangement can reduce the space occupied by the flexible printed circuit board 22 in the length direction of the cell 1, thereby reducing the overall volume of the battery and increasing the energy density of the battery.

That is, the battery provided by the disclosure not only enables effective protection of elements such as the protection board 2 located on the top of the cell 1, thereby reducing, to a certain extent, the risk of damage to the elements caused by impacts. Moreover, it ensures that the flexible printed circuit board 22 has a sufficient active space, facilitating flexible adjustment of the position of the output end 221 of the flexible printed circuit board 22, and it is also possible to better accommodate and conceal the bent portion of the flexible printed circuit board 22, thereby avoiding situations such as damage caused by compression, and further increasing the energy density of the battery.

For example, with reference to FIG. 6, the protection board 2 includes two flexible printed circuit boards 22. The two flexible printed circuit boards 22 are respectively connected to the main board 21 and are arranged on opposite sides of the main board 21 in the first direction. Illustratively, for example, the flexible printed circuit board 22 located on the right side outputs from a positive terminal of the cell 1, while the flexible printed circuit board 22 located on the left side outputs from a negative terminal of the cell 1. The groove 31 is respectively disposed at the position of the injection-molded plastic structure 3 corresponding to the output end 221 of each flexible printed circuit board 22, and each output end 221 extends into the corresponding groove 31.

By providing two flexible printed circuit boards 22, the current flow capability of the battery can be improved, the internal resistance of the battery is reduced, and the temperature rise of the battery is thus decreased, so that performance such as the rate capability of the battery is improved.

As another example, with reference to FIGS. 8 to 11, the protection board 2 includes one flexible printed circuit board 22, and the flexible printed circuit board 22 outputs, for example, from the positive terminal of the cell 1. The injection-molded plastic structure 3 has the groove 31 at the position corresponding to the output end 221 of the flexible printed circuit board 22, for the output end 221 to extend.

With reference to FIG. 7, in some embodiments, the groove 31 may specifically include: a first side groove wall 311 and a groove base wall 313 connected to an end of the first side groove wall 311 that is close to the top sealing edge 111, and the output end 221 extends into the groove 31 from the first side groove wall 311. The end of the first side groove wall 311 that is close to the top sealing edge 111 may specifically be the bottom end of the first side groove wall 311 in FIG. 7.

In a specific implementation, if an included angle between the first side groove wall 311 and the groove base wall 313 is too small, such as being an acute angle, it may cause difficulty in demolding after the completion of the injection molding process, and interference may occur between a mold and other components after the injection molding has been completed. However, if the included angle between the first side groove wall 311 and the groove base wall 313 is too large, it may cause a reduction in the thickness of the injection-molded plastic above the protection board 2, which may easily cause insufficient plastic filling, thereby exposing the board and thus affecting the insulation performance and the protection effect of the protection board 2.

In view of this, with reference to FIG. 7, in some embodiments, the included angle a between the first side groove wall 311 and the groove base wall 313 may be set between 90° and 100°.

That is, with reference to FIG. 7, the first side groove wall 311 may be disposed perpendicular to the groove base wall 313, or the first side groove wall 311 may be disposed to extend obliquely to the left, with an included angle a being not greater than 100°. Illustratively, the included angle a may be, for example, 90°, 91°, 92°, 93°, 94°, 95°, 96°, 97°, 98°, 99°, or 100°.

Such an arrangement not only ensures the thickness of the injection-molded plastic above the protection board 2, thereby ensuring the insulation effect and the protection effect, but also ensures smooth demolding. In additional, the internal space of the groove 31 is further increased, thereby providing a sufficiently large space for movement of the flexible printed circuit board 22, facilitating production and assembly.

With continued reference to FIG. 7, in some embodiments, the groove opening of the groove 31 has a width in the first direction that is greater than the width of the groove base of the groove 31 in the first direction, and the groove base wall 313 has a width L of not less than 2 mm in the first direction.

That is, by setting the minimum groove width of the groove 31 to be not less than 2 mm, the internal space of the groove 31 is further ensured, thereby further ensuring that the groove 31 can accommodate more redundant dimensions of the flexible printed circuit board 22, and further ensuring a sufficient space for movement of the flexible printed circuit board 22.

With reference to FIGS. 2 to 5, the top sealing edge 111 is formed with a sealing edge protrusion 113 on at least one side in the first direction. The first direction may specifically refer to the left-right direction shown in FIGS. 2 and 3. For example, sealing edge protrusions 113 are formed on both the left side and the right side of the top sealing edge 111 in the first direction.

By providing the sealing edge protrusion 113, the insulating protection for a corner position of the cell body can be improved to a certain extent. Illustratively, the sealing edge protrusion 113 may be formed by the top sealing edge 111 and the side sealing edge 112 together, that is, after the top sealing edge 111 and the side sealing edge 112 are bent, the sealing edge protrusion 113 is formed at the joint between them.

With reference to FIGS. 6 to 11, the injection-molded plastic structure 3 also encloses the sealing edge protrusion 113. That is, the injection-molded plastic structure can also protect the sealing edge protrusion 113, thereby achieving insulation of the sealing edge protrusion 113 and preventing situations such as short circuits caused by contact between the sealing edge protrusion 113 and other components. In addition, providing protection for the sealing edge protrusion 113 avoids situations such as damaged to the sealing edge protrusion 113 caused by compression due to external force.

With continued reference to FIGS. 6 to 10, an injection-molded boss 32 is formed in a region of the injection-molded plastic structure 3 that correspondingly encloses the sealing edge protrusion 113. The groove 31 further includes a second side groove wall 312 disposed opposite to the first side groove wall 311, an end of the second side groove wall 312 that is close to the top sealing plate is connected to the groove base wall 313, and a side of the injection-molded boss 32 facing the output end 221 is formed as the second side groove wall 312.

By providing the injection-molded boss 32, the side of the injection-molded boss 32 facing the output end 221 is formed as the second side groove wall 312 of the groove 31, thereby achieving better protection for the flexible printed circuit board 22 within the groove 31.

With reference to FIG. 7, in some embodiments, the width D of the top face of the injection-molded boss 32 is not less than 1.5 mm in the first direction. The width D herein refers to the dimension of the top face of the injection-molded boss 32 in the left-right direction in FIG. 7. Illustratively, the width D may be, for example, 1.5 mm, 1.55 mm, 1.6 mm, 1.7 mm, 1.8 mm, or 1.9 mm.

By setting the width D to be not less than 1.5 mm, it is possible to ensure that the top face of the injection-molded boss 32 has a sufficient width to a certain extent, thereby ensuring the protection strength of the injection-molded plastic at the injection-molded boss 32 to the sealing edge protrusion 113, and further improving the strength, insulation performance, and overall stability of the sealing edge protrusion 113.

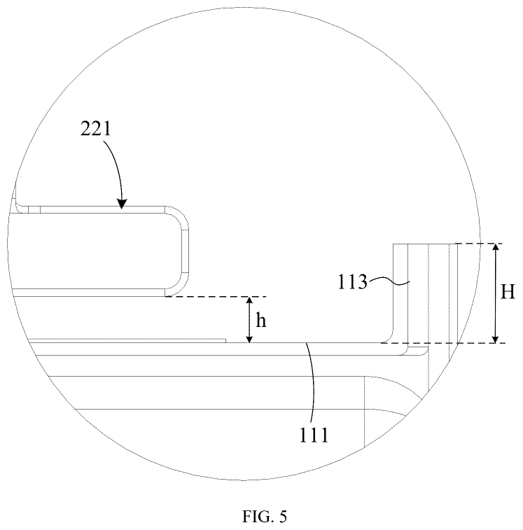

With reference to FIGS. 4 and 5, in some embodiments, a level h of the face of the output end 221 that is close to the top sealing edge 111 is not higher than a level H of the top face of the sealing edge protrusion 113.

The face of the output end 221 that is close to the top sealing edge 111 herein may specifically be the bottom face of the output end 221 as shown in FIG. 5. The level h of the face of the output end 221 that is close to the top sealing edge 111 may specifically refer to the vertical distance between the bottom face of the output end 221 and the top face of the top sealing edge 111 after being bent. The level H of the top face of the sealing edge protrusion 113 may specifically refer to the vertical distance between the top face of the sealing edge protrusion 113 and the top face of the top sealing edge 111 after being bent.

In this case, the injection-molded boss 32 as described above may specifically be formed in the region of the injection-molded plastic structure 3 that correspondingly encloses the sealing edge protrusion 113.

With continued reference to FIGS. 6 and 7, in some embodiments, an included angle b between the second side groove wall 312 and the groove base wall 313 may be set between 90° and 150°.

That is, the side groove wall of the injection-molded boss 32 facing the groove 31 may be set perpendicular to the groove base wall 313, or in the direction from bottom to top as shown in FIG. 7, the side groove wall of the injection-molded boss 32 facing the groove 31 may extend outwardly in an inclined manner, where the inclination angle does not exceed 150°.

Illustratively, the included angle b may be, for example, 90°, 95°, 100°, 110°, 115°, 117.5°, 120°, 130°, 135°, 140°, 145°, or 150°.

Such an arrangement not only ensures effective enclosure of the sealing edge protrusion 113 by the injection-molded plastic, but also further increases the internal space of the groove 31, providing more space for the bending adjustment of the flexible printed circuit board 22, thus facilitating the bending adjustment of the flexible printed circuit board 22. Moreover, setting the angle of the second side groove wall 312 within the aforementioned range facilitates demolding after the completion of the injection molding process, avoids interference of the mold during demolding, and ensures smooth demolding.

Further, the included angle between the second side groove wall 312 and the groove base wall 313 may be specifically set between 95° and 140°, so as to further ensure the space for movement of the flexible printed circuit board 22, ensure the enclosing effect of the injection-molded plastic on the sealing edge protrusion 113, and further ensure smooth demolding.

In some embodiments, the level of the face of the output end 221 that is close to the top sealing edge 111 is higher than the level of the top face of the sealing edge protrusion 113. With reference to FIG. 5, the face of the output end 221 that is close to the top sealing edge 111 herein may specifically be the bottom face of the output end 221 as shown in FIG. 5. The level h of the face of the output end 221 that is close to the top sealing edge 111 may specifically refer to the vertical distance between the bottom face of the output end 221 and the top face of the top sealing edge 111 after being bent. The level H of the top face of the sealing edge protrusion 113 may specifically refer to the vertical distance between the top face of the sealing edge protrusion 113 and the top face of the top sealing edge 111 after being bent.

In this case, the injection-molded boss 32 as described above may be formed in the region of the injection-molded plastic structure 3 that correspondingly encloses the sealing edge protrusion 113. For example, the injection-molded boss 32 formed in this case may have a relatively lower level in the vertical direction. Accordingly, while ensuring an effective enclosing effect of the injection-molded plastic on the sealing edge protrusion 113, excessive injection-molded plastic in the region corresponding to the sealing edge protrusion 113 is also avoided, thereby preventing plastic waste.

Illustratively, an included angle between the top face of the region of the injection-molded plastic structure 3 that encloses the sealing edge protrusion 113 and a horizontal plane may range from −10° to 10°. For example, the included angle between the top face of the injection-molded boss 32 and the horizontal plane may range from −10° to 10°. Illustratively, the included angle herein may be −10°, −5°, 0°, 5°, or 10°.

In this case, of course, the injection-molded boss 32 may not be formed in the region of the injection-molded plastic structure 3 that correspondingly encloses the sealing edge protrusion 113. Specifically, the level of the top face of the region of the injection-molded plastic structure 3 that encloses the sealing edge protrusion 113 may be not higher than the level of the groove base wall 313.

Illustratively, with reference to FIG. 11, the top face of the region of the injection-molded plastic structure 3 that encloses the sealing edge protrusion 113 is flush with the groove base wall 313.

With the above setting, while ensuring an effective enclosing effect of the injection-molded plastic on the sealing edge protrusion 113, excessive injection-molded plastic in the region corresponding to the sealing edge protrusion 113 is also avoided, thereby preventing plastic waste and reducing production costs.

Due to the relatively small dimension of the injection-molded boss 32, that is, the relatively small force-bearing area, if the level of the top face of the injection-molded boss is relatively high, then when the cell 1 is subjected to pressure (for example, during a cell reliability test), it is likely to apply excessive pressure to the injection-molded boss and the sealing edge protrusion 113, resulting in increased stress on the side of the cell in the length direction of the cell, and further resulting in deformation of and damage to the injection-molded boss 32, the sealing edge protrusion 113, the side sealing edge 112, etc. In view of this, in some embodiments, with reference to FIG. 6, the flexible printed circuit board 22 is disposed on at least one side of the protection board 2 in the first direction, and a level X1 of the top face of the region of the injection-molded plastic structure 3 that at least encloses the main board 21 is not lower than a level X2 of the top face of the injection-molded boss 32.

The first direction herein specifically refers to the up-down direction in FIG. 6, for example, the length direction of the cell 1. The level X1 of the top face of the region of the injection-molded plastic structure 3 that at least encloses the main board 21 may specifically refer to the vertical distance from the top face of the region of the injection-molded plastic structure 3 that encloses the main board 21 to the bottom face of the cell 1. The level X2 of the top face of the injection-molded boss 32 may specifically refer to the vertical distance from the top face of the injection-molded boss 32 to the bottom face of the cell 1.

Illustratively, the main board 21 is located in a central region on the top of the cell 1 in the left-right direction in FIG. 6, and there are two flexible printed circuit boards 22. The two flexible printed circuit boards 22 are located on opposite sides of the main board 21 in the left-right direction in FIG. 6, and the level of the top face of the central region of the injection-molded plastic structure 3 is not lower than the level of the top faces of the injection-molded bosses 32 on both sides.

With the above-described arrangement, excessive pressure on the sealing edge protrusion 113 and the injection-molded boss 32 can be effectively avoided when the cell 1 is under pressure, thus avoiding situations such as excessive force on a side edge of the cell in the length direction, which leads to damage to the sealing edge, ensuring the stability and longevity of the cell 1.

In the description, it should be noted that, unless expressly stated and defined otherwise, the terms “mounted”, “connected”, and “connection” should be understood in a broad sense, for example, it may be a fixed connection, or an indirect connection through an intermediate medium, and may be the communication between the interiors of two elements or the interaction between two elements. For those of ordinary skill in the art, the specific meaning of the terms mentioned above in the present application should be construed according to specific circumstances. In addition, orientation or position relationships indicated by the terms such as “up”, “down”, “left”, “right”, “front”, “rear”, “vertical”, “horizontal”, “top”, “bottom”, “inside”, and “outside” are based on orientation or position relationships shown in the accompanying drawings and are merely for ease of description of the disclosure and simplification of the description, rather than indicating or implying that the apparatuses or elements referred to must have a specific orientation or be constructed and operated in a specific orientation, and therefore cannot be construed as limiting the disclosure.

In the description, relationship terms such as “first” and “second” are merely used to distinguish an entity or operation from another entity or operation, and do not necessarily require or imply that any such actual relationship or order exists between those entities or operations. Moreover, the terms “include”, “comprise”, or any other variations thereof are intended to cover non-exclusive inclusion, so that a process, method, article, or apparatus that includes a series of elements not only includes those elements but also includes other elements not specifically listed, or elements inherent to such a process, method, article, or apparatus. Without further limitation, an element defined by the phrase “including a . . . ” does not exclude the presence of additional identical elements in the process, method, article, or apparatus that includes the element.

The above description only represents preferred embodiments of the disclosure and is not intended to limit the disclosure. Any modifications, equivalent substitutions, or other changes made within the spirit and principles of the disclosure should be included within the scope of protection of the disclosure.

What is claimed is:

1. A battery, comprising a cell, a protection board, and an injection-molded plastic structure,
wherein the cell has a tab and a top sealing edge, the tab extending from the top sealing edge; the protection board is connected to the tab, and the protection board comprises a main board located on a side of the top sealing edge facing away from the cell and at least one flexible printed circuit board connected to the main board;
the injection-molded plastic structure encloses at least the tab, the top sealing edge, the main board and a portion of the flexible printed circuit board, an output end of the flexible printed circuit board is located outside the injection-molded plastic structure, and a groove is formed on the injection-molded plastic structure at a position corresponding to where the output end extends, with at least a portion of the output end being located within the groove; and
the groove has a minimum groove width of not less than 2 mm in a first direction, and the groove has a groove depth of not less than 0.5 mm in a second direction.

2. The battery according to claim 1, wherein the groove comprises a first side groove wall and a groove base wall connected to an end of the first side groove wall that is close to the top sealing edge, and the output end extends into the groove from the first side groove wall.

3. The battery according to claim 2, wherein an included angle between the first side groove wall and the groove base wall ranges from 90° to 100°;
and/or a groove opening of the groove has a width in the first direction that is greater than a width of a groove base of the groove in the first direction, and the groove base wall has a width of not less than 2 mm in the first direction.

4. The battery according to claim 2, wherein the top sealing edge is formed with a sealing edge protrusion on at least one side in the first direction, and the injection-molded plastic structure further encloses the sealing edge protrusion.

5. The battery according to claim 4, wherein an injection-molded boss is formed in a region of the injection-molded plastic structure that correspondingly encloses the sealing edge protrusion; and
the groove further comprises a second side groove wall disposed opposite the first side groove wall, an end of the second side groove wall that is close to the top sealing edge is connected to the groove base wall, and a side of the injection-molded boss facing the output end is formed as the second side groove wall.

6. The battery according to claim 5, wherein a top face of the injection-molded boss has a width of not less than 1.5 mm in the first direction.

7. The battery according to claim 5, wherein a level of a face of the output end that is close to the top sealing edge is not higher than a level of a top face of the sealing edge protrusion;
and/or an included angle between the second side groove wall and the groove base wall ranges from 90° to 150°.

8. The battery according to claim 7, wherein the included angle the second side groove wall and the groove base wall ranges from 95° to 140°.

9. The battery according to claim 4, wherein a level of a face of the output end that is close to the top sealing edge is higher than a level of a top face of the sealing edge protrusion;
and/or an included angle between a top face of a region of the injection-molded plastic structure that encloses the sealing edge protrusion and a horizontal plane ranges from −10° to 10°;
and/or a level of the top face of the region of the injection-molded plastic structure that encloses the sealing edge protrusion is not higher than a level of the groove base wall.

10. The battery according to claim 5, wherein the flexible printed circuit board is disposed on at least one side of the main board in the first direction; and
a level of a top face of a region of the injection-molded plastic structure that at least encloses the main board is not lower than a level of a top face of the injection-molded boss.
